(19) United States
(12) Patent Application Publication
(10) Pub. No.: US 2007/0245134 A1
(43) Pub. Date: Oct. 18, 2007

(54) TESTING DEVICE AND TESTING METHOD FOR COMPUTER

(75) Inventors: Ya-Bin Liu, Shenzhen (CN); Li-Ping Chen, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,114

(22) Filed: Jun. 23, 2006

(30) Foreign Application Priority Data
Apr. 12, 2006 (CN) 200610060271.1

(51) Int. Cl. G06F 9/00

(52) U.S. Cl. 713/2

(57) ABSTRACT

A testing device is provided to include a pre-boot execution environment (PXE) server, a dynamic host configuration protocol (DHCP) server, and a computer. The computer is connected to the PXE server and the DHCP server via a network. The PXE server includes an image file stored therein, a communicating module of server terminal and a communicating module of client terminal. The computer includes a network device for supporting PXE functions. A testing method is provided to include following steps: connecting the PXE server and the DHCP server to the computer via the network, the DHCP server assigning an IP address to the computer, the computer downloading the communicating module of client terminal from the PXE server, for communicating with the communicating module of server terminal, and the image file being run to test the computer.

### FIELD OF THE INVENTION

The present invention relates to testing devices and testing methods, more particularly to a testing device and a testing method for a computer without a data storage device.

### DESCRIPTION OF RELATED ART

After a computer is produced, a test for the quality of computer is required. A conventional test device includes a pre-boot execution environment (PXE) server, a dynamic host configuration protocol (DHCP) server, and a computer to be tested having a data storage device. A testing module for testing the computer is stored in the PXE server. In testing, the computer system is started up, and the testing module is downloaded to the data storage device of the computer. Then the testing module is run to test the computer.

However, customers may have different demands regarding configurations of computers systems. Some computers may have no data storage device. Therefore, no operating system or testing files can be installed in these computers. The conventional testing method is not usable for testing computers without data storage devices.

What is needed, therefore, is a testing device and a testing method for testing a computer without a data storage device.

### SUMMARY OF THE INVENTION

A testing device is provided to include a pre-boot execution environment (PXE) server, a dynamic host configuration protocol (DHCP) server, and a computer. The computer is connected to the PXE server and the DHCP server via a network. The PXE server includes an image file stored therein, a communicating module of server terminal, and a communicating module of client terminal. The computer includes a network device for supporting PXE functions. A testing method is provided to include the following steps: connecting the PXE server and the DHCP server to the computer via the network, the DHCP server assigning an IP address to the computer, the computer downloading the communicating module of client terminal from the PXE server, for communicating with the communicating module of server terminal, and the image file is run to test the computer.

Other advantages and novel features will be drawn from the following detailed description of preferred embodiments with attached drawings, in which:

### BRIEF DESCRIPTION OF THE DRAWINGS

FIG. 1 is a block diagram of a testing device in accordance with a preferred embodiment of the present invention, the testing system including a DHCP server, a PXE server, and a computer; and

FIG. 2 is a flow chart of a testing method in accordance with a preferred embodiment of the present invention.

### DETAILED DESCRIPTION OF THE INVENTION

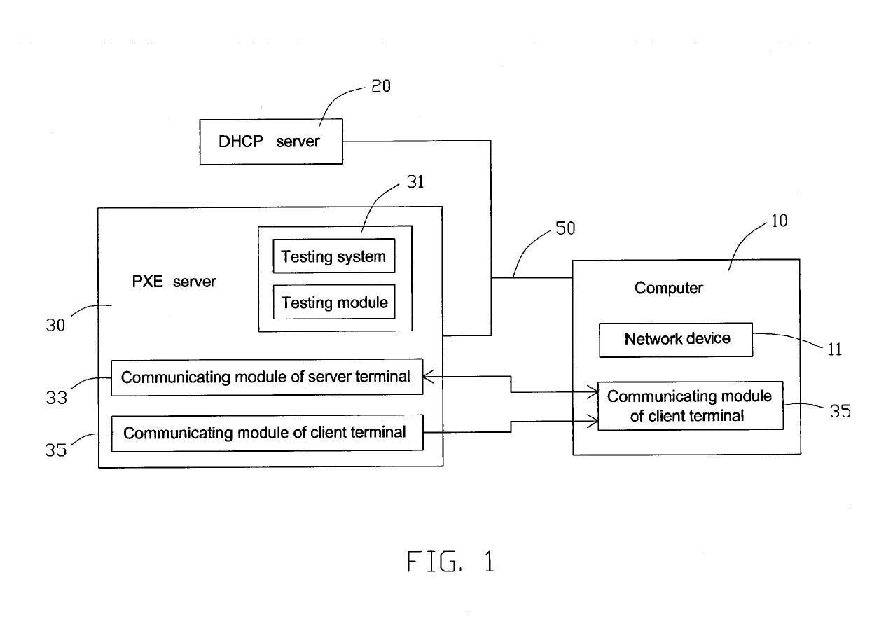

Referring to FIG. 1, a testing device in accordance with a preferred embodiment of the present invention, includes a computer 10 without data storage device to be tested, a dynamic host configuration protocol (DHCP) server 20, and a pre-boot execution environment (PXE) server 30. The DHCP server 20 and the PXE server 30 are connected to the computer 10 via a network 50. The computer 10 includes a network device 11 supporting PXE functions. In the present embodiment, the network device 11 is a network card. The DHCP server 20 is used for assigning an IP address to the computer 10 via the network card.

An image file 31 including a testing system and a testing module is stored in the PXE server 30, for testing the computer 10. The PXE server 30 further includes a starting module and a communicating module of server terminal 33. The starting module is set to become a communicating module of client terminal 35. The communicating module of client terminal 35 can be downloaded to a memory of the computer 10, for starting the computer 10 and communicating with the communicating module of server terminal 33. Thus, the computer 10 communicates with the PXE server 30. The testing system is started up, and the testing module in the PXE server 30 is run to test the computer 10.

In another embodiment, functions of the PXE server 30 and the DHCP server 20 can also be integrated in one server.

When testing, the computer 10 downloads the communicating module of client terminal 35 from the PXE server 30. Then, the communicating module of client terminal 35 in the computer 10 communicates with the communicating module of server terminal 33 in the PXE server 30. The computer 10 accesses the image files 31 in the PXE server 30. The testing system and testing module are started up to test the computer 10.

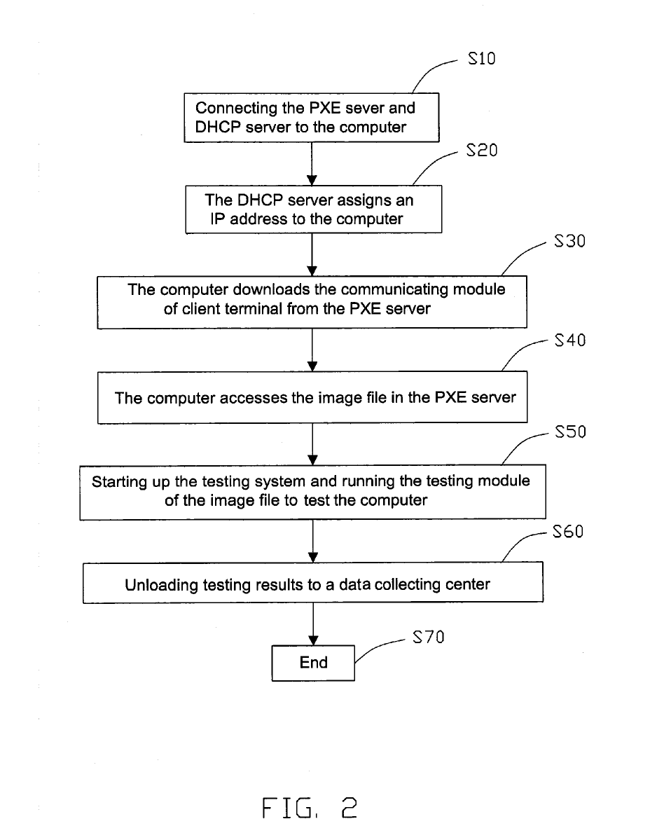

Referring also to FIG. 2, the testing method for testing the computer 10 includes following steps:

Step 10: connecting the PXE server 30 and DHCP server 20 to the computer 10 via the network 50;

Step 20: the DHCP server 20 assigns an IP address to the computer 10;

Step 30: the computer 10 downloads the communicating module of client terminal 35 from the PXE server 30;

Step 40: the computer 10 accesses the image file 31 in the PXE server 30;

Step 50: starting up the testing system and running the testing module of the image files 31 to test the computer 10;

Step 60: uploading test results to a data collecting center; and

Step 70: testing process ends.

Compared with the conventional testing device and testing method, the testing method can test computers that do not have a data storage device. Furthermore, the testing module is directly run on a network to test the computer 10, shortening the testing period.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A testing device comprising:
a pre-boot execution environment (PXE) server having an image file stored therein, the PXE server comprising a communicating module of server terminal and a communicating module of client terminal;
a computer comprising a network equipment supporting a function of PXE; and
a dynamic host configuration protocol (DHCP) server for assigning an IP address to the computer, the DHCP server and PXE server respectively connected to the computer via a network;
wherein the computer is capable of downloading the communicating module of client terminal from the PXE server, thereby communicating with the communicating module of server terminal so that the image files is run to test the computer.

2. The testing device as described in claim 1, wherein the image files comprises a testing system and a testing module, when the computer gets communication with the PXE server, the testing system is started up, and the testing module is run to test the computer.

3. The testing device as described in claim 1, wherein functions of the PXE server and the DHCP server are integrated into one server.

4. A testing method for testing a computer, comprising:
connecting a pre-boot execution environment (PXE) server and a dynamic host configuration protocol (DHCP) server to the computer via a network, the PXE server comprising an image file and a starting module, the image file comprising a testing system and a testing module, the computer comprising a network device for supporting PXE functions;
the DHCP server assigning an IP address to the computer;
the computer downloading the starting module from the PXE server, for communicating with the PXE server; and
the computer accessing the image file, the testing system being started up, the testing module being run to test the computer.

5. The testing method as described in claim 4, wherein a communicating module of server terminal is disposed in the PXE server to communicate with the starting module downloaded to the computer.

6. The testing method as described in claim 4, wherein the starting module is a communicating module of client terminal disposed in the PXE server.

7. The testing method as described in claim 4, further comprising uploading test results to a data collecting center.

8. A testing device comprising:
a pre-boot execution environment (PXE) server having an image file stored therein, the PXE server comprising a starting module and a communicating module of server terminal; and
a computer communicating with the PXE server via a network;
wherein the computer is capable of downloading the starting module from the PXE server to thereby communicate with the communicating module of server terminal so that the image files is run to test the computer.

9. The testing device of claim 8, wherein the image file comprises a testing module for testing the computer, and a testing system for supporting running of the testing module.

10. The testing device of claim 9, further comprising a dynamic host configuration protocol (DHCP) server for assigning an IP address to the computer whereby the computer is capable of downloading the starting module from the PXE server.

11. The testing device of claim 8, wherein the starting module is a communicating module of client terminal.
